(19) United States
(12) Patent Application Publication
(10) Pub. No.: US 2017/0080354 A1
(43) Pub. Date: Mar. 23, 2017

(54) Thin-Film Evaporator with Screw Outfeed

(71) Applicant: Artisan Industries Inc., Stoughton, MA (US)

(72) Inventors: James Russell Steeves, Ayer, MA (US); Craig Karl Wallace, Braintree, MA (US)

(21) Appl. No.: 14/600,546

(22) Filed: Jan. 20, 2015

(51) Int. Cl. B01D 1/22

(52) U.S. Cl. CPC B01D 1/226

(57) ABSTRACT

A thin-film evaporator (TFE) includes a cylindrical body and blades disposed therein. However, to avoid clogging within a “dead zone” of a conventional discharge nozzle coupled to the cylindrical body of the TFE, an integrated drive screw apparatus intersects the cylindrical body of the TFE. The drive screw apparatus extracts processed material from the cylindrical body and ejects the processed material via a discharge nozzle coupled to the drive screw apparatus. The intersection of the cylindrical body of the TFE and the drive screw apparatus effectively reduces (possibly to zero) length of the dead zone.

### TECHNICAL FIELD

The present invention relates to thin-film evaporators (TFEs), and, more particularly, to thin-film evaporators having drive screw outfeeds.

### BACKGROUND ART

It is known in the prior art to use a vertical or horizontal thin-film evaporator (“TFE”) to remove a solvent from a resin, dehydrate a food product, purify an antioxidant or perform a chemical reaction in relation to processing thermally unstable, viscous, solids-containing and foaming materials. See, for example U.S. Pat. Nos. 4,160,692, 5,582,692 and 6,160,143, the entire contents of which are hereby incorporated by reference. Using a thin-film evaporator entails placing a thin film of the material being processed on an inner wall of an externally heated (typically cylindrical) chamber to provide a surface for evaporation.

In a conventional thin-film evaporator, feed material is introduced via a feed nozzle near one end of the apparatus. A rotor rotates one or more blades inside the chamber. The blade(s) wipe or otherwise spread the feed material on the inside wall of the evaporator and drive the progressively dryer material toward the other end of the apparatus. A concentrated or dried product is removed via a discharge nozzle located at or near the other end of the apparatus. Vapor is removed from the apparatus via a third nozzle. Each nozzle includes a length of pipe (a “neck”) and a flange, by which the nozzle may be coupled to other process equipment.

In a typical thin-film evaporator used in an industrial-scale food or chemical processing context, the neck may be about four inches (10.2 cm) long, and the flange may be about one inch (2.5 cm) thick. The nozzle, therefore, defines a “dead zone” radially outward of the inner wall of the TFE. Dry or sticky material produced in the apparatus tends to clog the dead zone of the discharge nozzle, reducing output and requiring frequent maintenance.

### SUMMARY OF EMBODIMENTS

An embodiment of the present invention provides a thin-film evaporator (TFE). The TFE includes a cylindrical body. The cylindrical body has a longitudinal axis. The cylindrical body defines an inner surface and an inner volume within the inner surface. A feed nozzle is in fluid communication with the inner volume of the cylindrical body. A rotor assembly is disposed within the inner volume of the cylindrical body. The rotor assembly has an axis of rotation. The axis of rotation of the rotor assembly is coaxial with the cylindrical body. At least one blade is disposed within the inner volume of the cylindrical body. The at least one blade is disposed adjacent the inner surface of the cylindrical body. The at least one blade is attached to the rotor assembly for rotation therewith. The TFE also includes an elongated body. The elongated body has a longitudinal axis. The elongated body defines an inner volume. The elongated body intersects the cylindrical body to define a window therebetween. The inner volume of the cylindrical body is in fluid communication with the inner volume of the elongated body via the window. At least one drive screw is disposed within the inner volume of the elongated body. The at least one drive screw has an axis of rotation. The axis of rotation of the at least one drive screw is parallel to the longitudinal axis of the elongated body. A discharge nozzle is in fluid communication with the inner volume of the elongated body.

The at least one blade may define a circumference swept by an outer edge thereof. The at least one drive screw may include a flight. The flight may have an outer circumference. A tangent of the outer circumference of the flight may be located less than about two inches (50 cm) from the circumference swept by the outer edge of the at least one blade.

The feed nozzle may include a flange. The flange may have a flange thickness. The tangent of the outer circumference of the flight may be located less than about two times the flange thickness from the circumference swept by the outer edge of the at least one blade.

The tangent of the outer circumference of the flight may be located no more than about ¼ inch (6.4 mm) from the circumference swept by the outer edge of the at least one blade. The tangent may be located no more than about 3/16 inch (4.8 mm) from the circumference swept by the outer edge of the at least one blade. The tangent may be located no more than about ⅛ inch (3.2 mm) from the circumference swept by the outer edge of the at least one blade. The tangent may be located no more than about 1/16 inch (1.6 mm) from the circumference swept by the outer edge of the at least one blade. The tangent may be located about zero inches (0 cm) from the circumference swept by the outer edge of the at least one blade. The outer circumference of the flight of the at least one drive screw may overlap the circumference swept by the outer edge of the at least one blade.

The tangent may be located a distance between about 1/16 inch (1.6 mm) and about ¼ inch (6.4 mm) from the circumference swept by the outer edge of the at least one blade. The tangent may be located a distance between about 1/16 inch (1.6 mm) and about ⅛ inch (3.2 mm) from the circumference swept by the outer edge of the at least one blade.

The cylindrical body may include a wall. The wall may define the window. The wall may have a wall thickness extending from the inner surface of the cylindrical body. The inner surface of the cylindrical body may define an inner surface circumference. The tangent of the outer circumference of the flight may be located a distance from the inner surface circumference of the cylindrical body less than the wall thickness.

The longitudinal axis of the cylindrical body may be substantially perpendicular to the longitudinal axis of the elongated body.

The at least one drive screw may include two parallel intermeshed drive screws that are configured to co-rotate. The at least one drive screw may include two parallel intermeshed drive screws that are configured to counter-rotate.

The cylindrical body may intersect the elongated body along a weld.

The TFE may also include a jacket surrounding at least a portion of the cylindrical body. The jacket may define a volume between the jacket and the cylindrical body. The jacket and the volume may be configured to transfer heat between a fluid flowing through the volume and the cylindrical body. A heat exchange fluid feed nozzle may be in fluid communication with the volume defined by the jacket. A heat exchange fluid discharge nozzle may also be in fluid communication with the volume defined by the jacket.

The at least one drive screw may be configured to rotate about its axis of rotation in a direction to transport material from the window, through at least a portion of the inner volume of the elongated body, toward the discharge nozzle.

### BRIEF DESCRIPTION OF THE DRAWINGS

The invention will be more fully understood by referring to the following Detailed Description of Specific Embodiments in conjunction with the Drawings, of which:

FIG. 1 is a front, cross-sectional view of a thin-film evaporator and its discharge nozzle, according to the prior art.

FIG. 2 is a perspective, cut-away view of a thin-film evaporator with a drive screw outfeed, according to an embodiment of the present invention.

FIG. 3 is an end view of the drive screw outfeed of FIG. 2.

FIG. 4 is a perspective, cut-away view of the apparatus of FIG. 2, without the drive screw outfeed, for clarity.

FIG. 5 is a perspective, exploded view of the apparatus of FIG. 2.

FIG. 6 is a front, cut-away view of an intersection of an evaporator body and the drive screw outfeed of the apparatus of FIGS. 2 and 5.

FIG. 7 is an enlarged view of a portion of FIG. 6.

FIG. 8 is a perspective, cut-away view of a jacket of a thin-film evaporator.

### DETAILED DESCRIPTION OF SPECIFIC EMBODIMENTS

In accordance with embodiments of the present invention, methods and apparatus are disclosed for drying or concentrating a feed material by spreading it on an inside (typically heated) surface of a cylindrical body and extracting processed material without clogging a discharge nozzle.

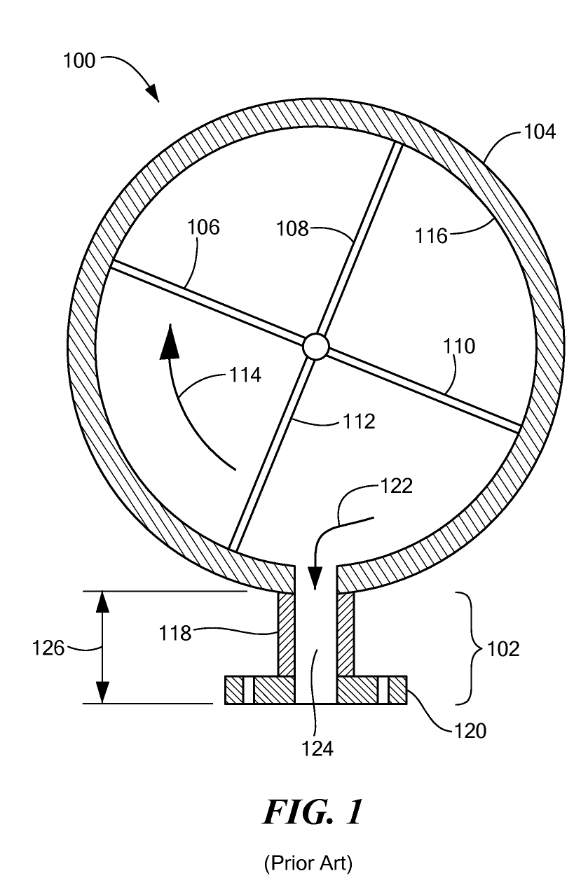

FIG. 1 is a cross-sectional view of a prior art thin-film evaporator (TFE) 100, including a discharge nozzle 102 attached to a cylindrical body 104. Blades 106, 108, 110 and 112 rotate, as indicated by arrow 114, to spread material to be processed on an inner surface 116 of the cylindrical body 104. The discharge nozzle 102 includes a pipe 118 and a flange 120. The flange 120 facilitates coupling the TFE 100 to other process equipment (not shown), such as a collection vessel or pump.

As the blades 106-112 rotate, they drive processed material into the pipe 118, as indicated by arrow 122. However, nothing operates to actively transport the processed material through the discharge nozzle 102, except gravity and hydraulic forces produced by the blades 106-112 112 as they drive more processed material into the pipe 118. The pipe 118 is typically about four inches (10.2 cm) long, and the flange 120 is typically about one inch (2.5 cm) thick, creating a “dead zone” 124 about five inches (127 cm) long 126.

As noted, dry or sticky processed material often becomes impacted in the dead zone 124, because gravity and the hydraulic forces generated by the blades 106-112 are insufficient to push the processed material already in the discharge nozzle 102. The discharge nozzle 102 therefore becomes clogged. It should be noted that any process equipment (not shown) coupled to the discharge nozzle 102 includes at least a flange and, in most cases, a pipe, and thereby effectively increasing the length 126 of the dead zone 124, exacerbating the problem.

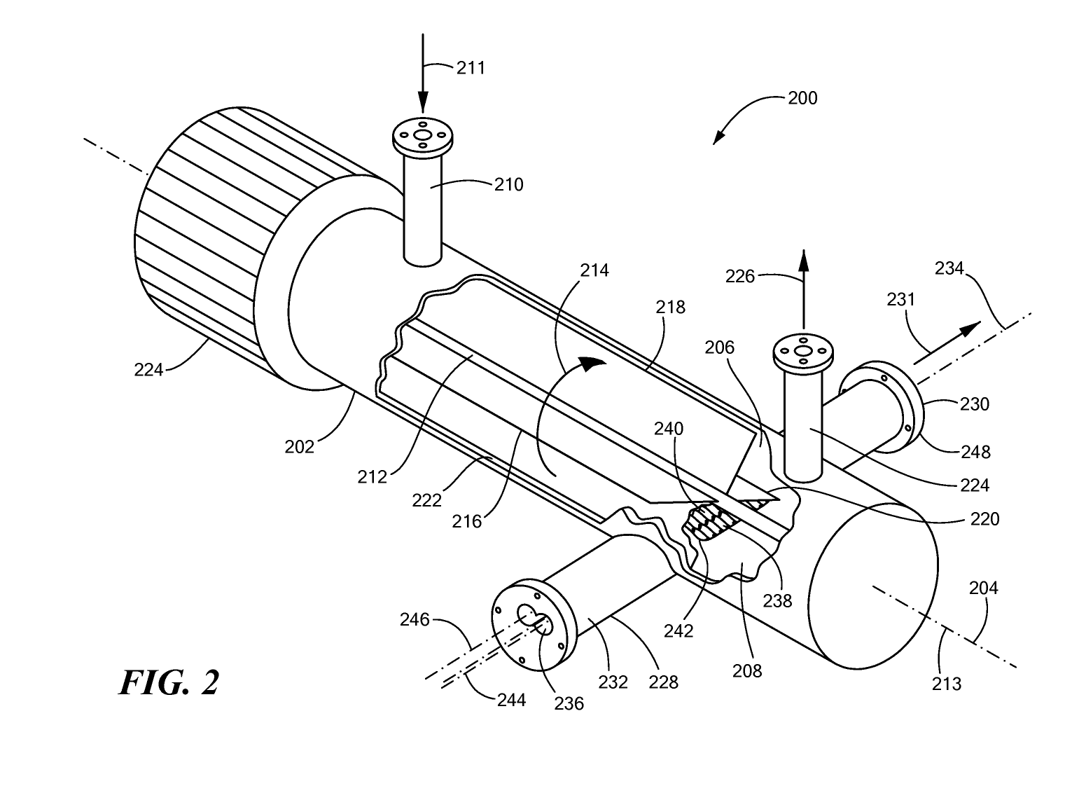

Embodiments of the present invention solve problems created by dead zones in prior art TFEs. FIG. 2 is a perspective, cut-away view of a mechanically agitated thin-film evaporator (TFE) 200, according to an embodiment of the present invention. The TFE 200 includes a cylindrical body 202. The cylindrical body 202 has a longitudinal axis 204. The cylindrical body 202 is shown oriented horizontally. However, the cylindrical body 202 may be oriented vertically, or it may be oriented at any other angle, relative to horizontal.

The body 202 defines an inner surface 206 and an inner volume 208 within the inner surface 206. A feed nozzle 210 is in fluid communication with the inner volume 208 of the cylindrical body 202. Material to be processed by the TFE 200 may be fed into the TFE 200 via the feed nozzle 210, as indicated by arrow 211, such as by other process equipment (not shown).

A rotor assembly 212 is disposed within the inner volume 208 of the cylindrical body 202. The rotor assembly 212 has an axis of rotation 213 coaxial with the axis 204 of the cylindrical body 202. Rotation is indicated by an arrow 214, although the rotation may be in either direction.

Four blades 216, 218, 220 and 222 are disposed within the inner volume 208 of the cylindrical body 202. However, one or more blades may be used. In some embodiments, other types of agitation elements, such as rollers, may be used. For simplicity of explanation, as used herein, the term “blade” includes blade, roller and/or other types of mechanical agitators known in the art for use in a mechanical agitated thin-film evaporator. The blades 216-222 are disposed adjacent the inner surface 208 of the cylindrical body 202. In some embodiments, outer edges of the blades 216-222 contact the inner surface 208 of the cylindrical body 202. In other embodiments, the outer edges of the blades 216-222 are close to, but spaced apart from, the inner surface 208. The blades 216-222 may be spaced a distance selected based on size of the cylindrical body 202, material to be processed and other factors known to those of skill in the art. The blades 216-222 are attached to the rotor assembly 212 for rotation therewith. A motor 224 and optional gear or belt drive (not visible) propel the rotor assembly 212.

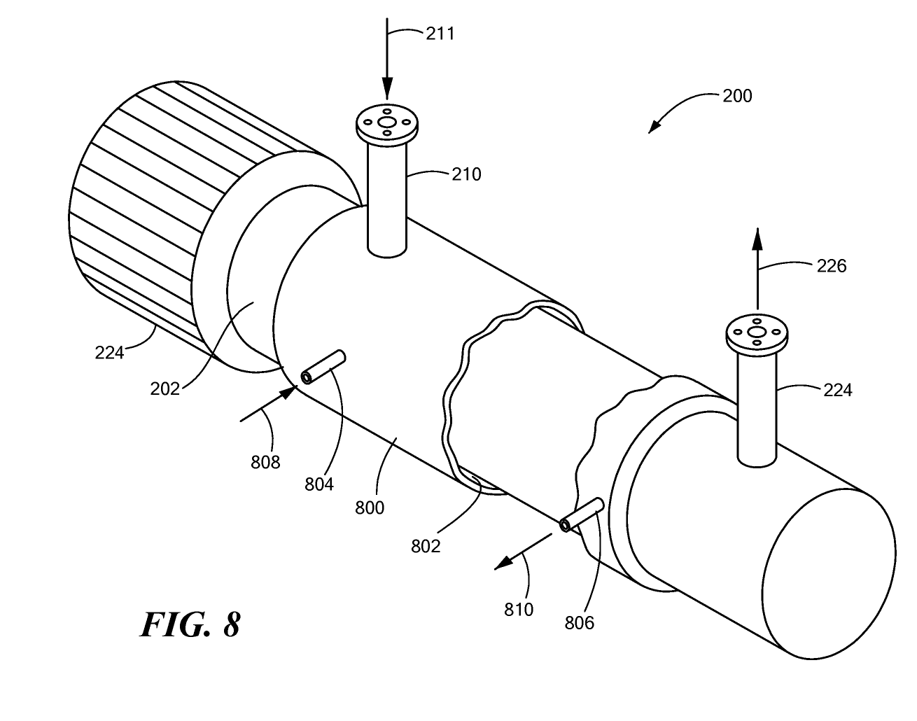

As shown in FIG. 8 (in which the drive screw apparatus 228 is omitted for clarity), the TFE 200 may include a jacket 800 surrounding at least a portion of the cylindrical body 202 to define a volume 802 between the jacket 800 and the cylindrical body 202. The jacket 800 may be configured to transfer heat between a fluid flowing through the volume 802 and the cylindrical body 202. A heat exchange fluid feed nozzle 804 and a heat exchange fluid discharge nozzle 806 may be in fluid communication with the volume 802 defined by the jacket 800. Heat exchange fluid, such as hot oil, hot water or steam, may be fed to heat exchange fluid feed nozzle 804, as indicated by arrow 808. The heat exchange fluid may flow through the volume 802 defined by the jacket 800 and exit via the heat exchange fluid discharge nozzle 806, as indicated by arrow 810. The heat exchange fluid may be supplied, heated and circulated by other process equipment (not shown).

Returning to FIG. 2, a vapor discharge nozzle 224 is in fluid communication with the inner volume 208 of the cylindrical body 202. Vapor released by the material being processed by the TFE 200 may escape or be drawn, such as under vacuum, from the TFE 200 via the vapor discharge nozzle 224, as indicated by arrow 226.

Operation of the blades 216-222 against the inner surface 206 of the cylindrical body 202, aided by heat (if necessary) supplied by the jacket 800, process the material fed into the TFE 200 in a conventional manner. However, unlike conventional TFEs, the TFE 200 does not discharge processed material via a discharge nozzle attached to the cylindrical body 202. As noted, such a discharge nozzle is subject to clogging by dry, sticky or other processed material. Instead, the TFE 200 includes an integrated drive screw apparatus 228 to extract the processed material from the cylindrical body 202 and eject the processed material via a discharge nozzle 230, as indicated by arrow 231. Although the drive screw apparatus 228 is shown in FIG. 2 to be horizontal, the drive screw apparatus 228 may be oriented at any angle, relative to horizontal.

The drive screw apparatus 228 includes an elongated body 232 having a longitudinal axis 234. The elongated body 232 defines an inner volume 236. In the embodiment shown in FIG. 2, the inner volume 236 has a figure-8 cross-sectional shape to accommodate two parallel, intermeshed drive screws 238 and 240. The elongated body 232 intersects the cylindrical body 202 along a weld to define a window 242 between the elongated body 232 and the cylindrical body 202. The inner volume 208 of the cylindrical body 202 is in fluid communication with the inner volume 236 of the elongated body 232 of the drive screw apparatus 228 via the window 242.

In the embodiment shown in FIG. 2, the longitudinal axis 204 of the cylindrical body 202 is substantially perpendicular to the longitudinal axis 234 of the elongated body 232. However, the cylindrical body 202 may be joined to the elongated body 232 so their respective longitudinal axes 204 and 234 form any desired angle.

In the embodiment shown in FIG. 2, two drive screws 238 and 240 are disposed parallel to each other within the inner volume 236 of the elongated body 232. However, in other embodiments, one or more drive screws may be used. The two drive screws 238 and 240 are disposed, such that flights of the drive screws 238 and 240 intermesh. A motor (not shown, but typically located at the near (in the view provided in FIG. 2) end of the drive screw apparatus 228) and optional gear or chain/belt (not shown) propel the drive screws 238 and 240 so they co-rotate, i.e., both drive screws 238 and 240 rotate in the same direction and at the same rate of rotation. This intermeshing and co-rotation causes the drive screws 238 and 240 to clean each other and/or self-clean. The drive screw shafts may be sealed at the motor end against the atmosphere by stuffing boxes or any other suitable seal.

Alternatively, the drive screws 238 and 240 are not intermeshed and/or rotate at different rates of rotation and/or rotate in opposite directions. For example, in some embodiments, the flights of the two drive screws are wound in opposite senses. These drive screws may be intermeshed and rotated in opposite directions (counter-rotated).

The cross-sectional shape of the inner volume 236 should correspond to the number of drive screws, more specifically, to a cross-sectional shape of the collective drive screw(s). Dimensions of the cross-sectional shape of the inner volume 236 should be slightly larger than outside diameters of the flights of the drive screws 238 and 240 to facilitate transporting the processed material, without allowing much or any of the processed material to remain adhered to inside walls of the elongated body 232. In some embodiments, the cross-sectional shape of the inner volume 236 provides about 0.02 inches (0.5 mm) clearance between the inside walls of the elongated body 232 and the outside diameters of the flights of the drive screws 238 and 240.

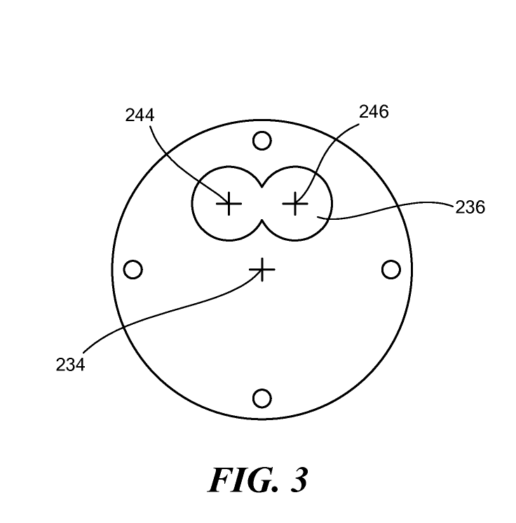

Each drive screw 238 and 240 has an axis of rotation 244 and 246, respectively, parallel to the longitudinal axis 234 of the elongated body 232 of the drive screw apparatus 228. An end view of the drive screw apparatus 228 is shown in FIG. 3. The axes of rotation 244 and 246 are co-planar, and the plane of the axes 244 and 246 is parallel to the longitudinal axis 204 of the cylindrical body 202.

Returning to FIG. 2, the discharge nozzle 230 is in fluid communication with the inner volume 236 of the elongated body 232 of the drive screw apparatus 228. The drive screws 238 and 240 can continuously transport processed material from the cylindrical body 202 to the discharge nozzle 230. The drive screws 238 and 240 rotate about their respective axes of rotation 244 and 246 in a direction to transport material from the window 242, through at least a portion of the inner volume 236 of the elongated body 232, toward the discharge nozzle 230.

The discharge nozzle 230 may be equipped with a flange 248 with a die orifice to create a seal and backpressure. In cases in which the TFE 200 is operated under vacuum, if the processed material is sufficiently viscous, the processed material may provide an adequate vacuum-to-atmosphere seal at the distal end of the discharge nozzle 230 and/or in connected downstream piping. However, if the processed material is free-flowing and non-viscous, another type of vacuum-to-atmosphere seal should be provided downstream of the TFE 200. For example, a pump (for liquid processed material) or a cycling air lock (for solid processed material) may be used. Alternatively, the discharge nozzle 230 may be left open for discharge of processed material into a collection vessel (not shown).

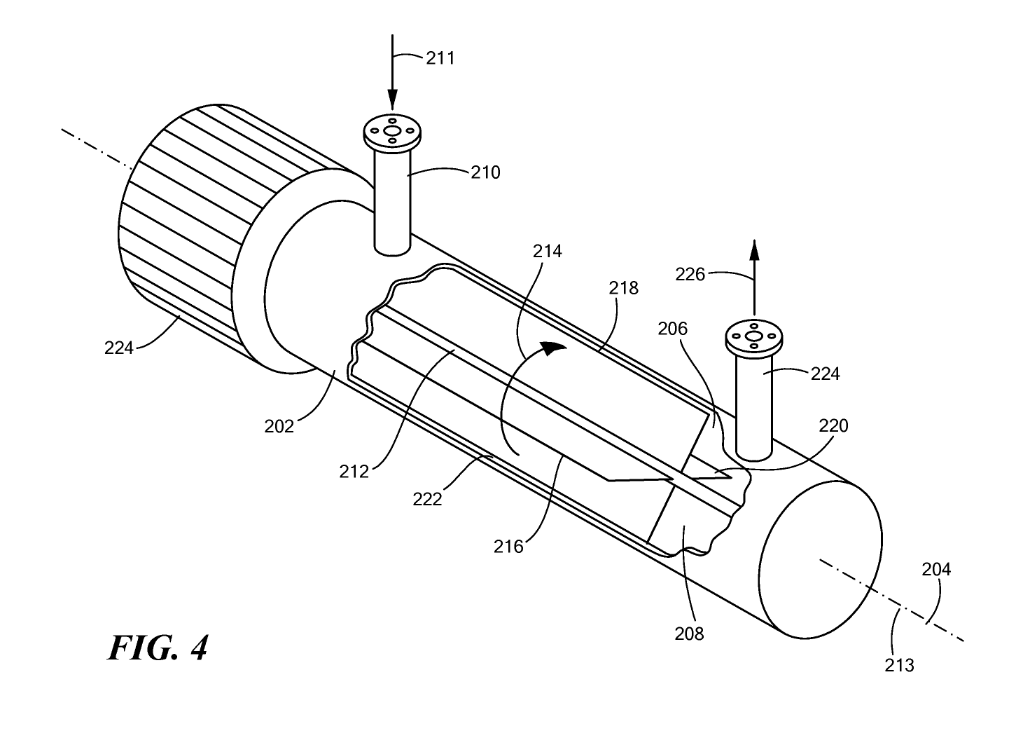

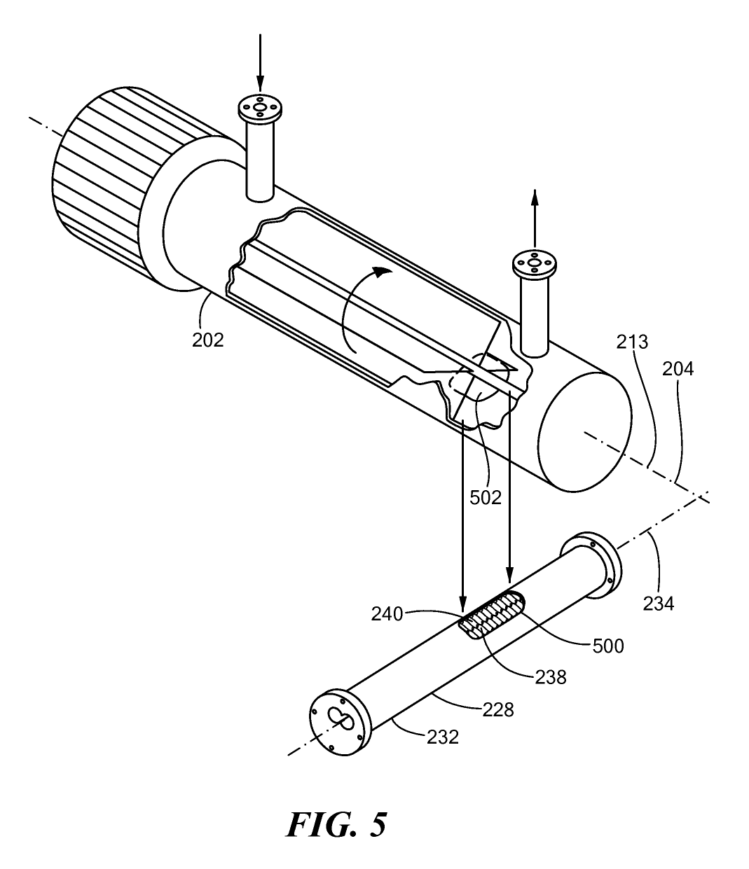

FIG. 4 is a perspective, cut-away view of the TFE 200, without the drive screw apparatus 228, for clarity. FIG. 5 a perspective, exploded view of the TFE 200. FIG. 5 reveals an opening 500 in the elongated body 232 of the drive screw apparatus 228. The opening 500 corresponds in size and position with a complementary opening 502 in the cylindrical body 202. When the elongated body 232 is joined to the cylindrical body 202, the two openings 500 and 502 form the window 242 described above, with respect to FIG. 2.

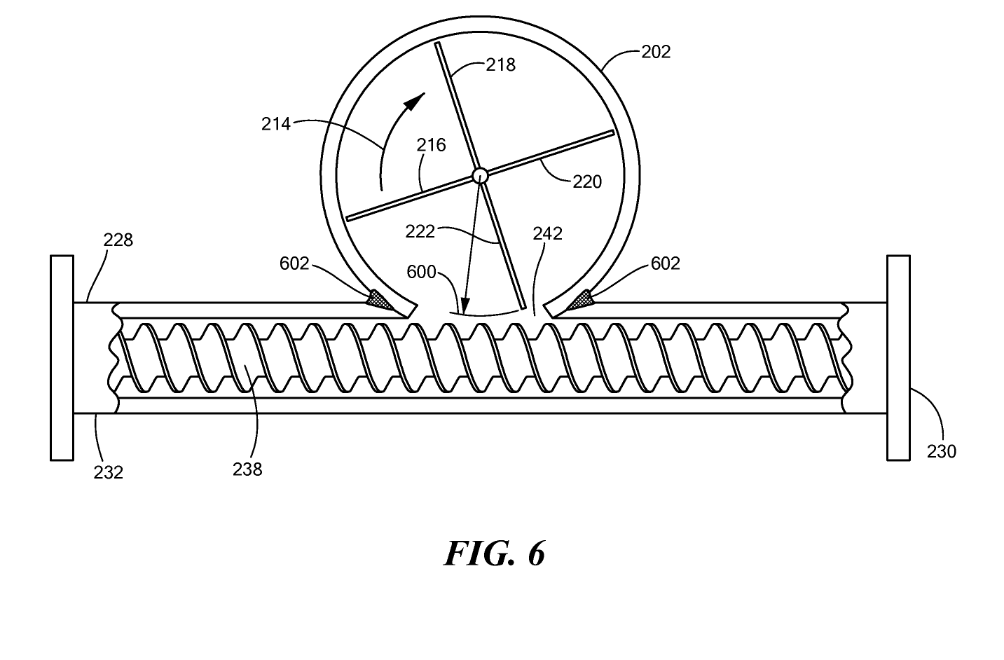

As noted, the elongated body 232 intersects the cylindrical body 202. FIG. 6 is a front, cut-away view of the intersection of the cylindrical body 202 and the elongated body 232, including the window 242. A circumference swept by an outer edge of the blades 216-222 is indicated at 600. In the embodiment shown in FIG. 6, the cylindrical body 202 is joined to the elongated body 232 by a weld 602. The weld 602 also mechanically joins together the cylindrical body 202 and the elongated body 232 into a single weldment.

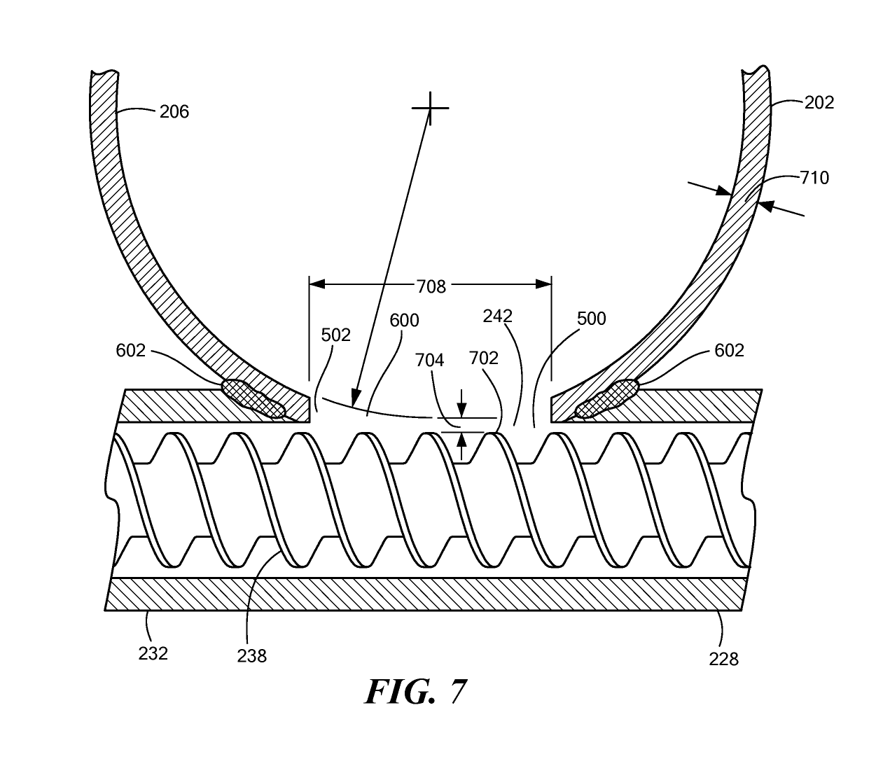

FIG. 7 is an enlarged view of a portion of FIG. 6. The blades 216-222 are not shown in FIG. 7, for clarity. The weld 602 surrounds the openings 500 and 502, thereby creating a process fluid-tight seal between the cylindrical body 202 and the elongated body 232 of the drive screw apparatus 228. In other embodiments, instead of a weld, the cylindrical body 202 may be joined to the elongated body 232 by a clamp (not shown) or any other suitable fastener, with a suitable gasket, if necessary, between the cylindrical body 202 and the elongated body 232.

The cylindrical body 202 and the elongated body 232 intersect, such that an outer circumference 702 of the flight of the drive screw 238 is arbitrarily close 704 to the circumference 600 swept by the outer edge of the blades 216-222. The term “intersect” is used herein in the geometric sense, i.e., an intersection is a point, line, curve, area or volume common in two or more objects. Walls of the cylindrical body 202 and the elongated body 232 are in common along the weld 700. No pipe or other neck interconnects the cylindrical body 202 to the elongated body 232.

In some embodiments, the distance 704 is about ⅛ inch (3.2 mm). In other words, the drive screw 238 flight has an outside circumference 702, a tangent of which is located less than about ⅛ inch (3.2 mm) from the circumference 600 swept by the outer edges of the blades 216-222. Proximity of the outer circumference 702 of the drive screw 238 flight to the circumference 600 swept by the outer edge of the blades 216-222 prevents clogging of the window 242 by processed material. Essentially, the intersected cylindrical body 202 and the elongated body 232 reduce the dead zone to such a short length (optionally zero) that the blades 106-112 can easily drive processed material far enough toward the drive screw 238 that the drive screw 238 takes up the processed material and transports it away from the window 242. In addition, width 708 of the window 242 is typically larger than an inside diameter of a prior art discharge nozzle 102 (FIG. 1), thereby reducing the likelihood of processed material clogging the window 242.

In some embodiments, the distance 704 is about 1/16 inch (1.6 mm). In some embodiments, the distance 704 is in a range of about 1/16 inch (1.6 mm) to about ⅛ inch (3.2 mm). In some embodiments, the distance 704 is less than or equal to about 3/16 inch (4.8 mm) or less than or equal to about ¼ inch (6.4 mm). In some embodiments, the distance 704 is in a range of about 1/16 inch (1.6 mm) to about ¼ inch (6.4 mm). In some embodiments, the distance 704 is less than a wall thickness 710 of the cylindrical body 206. In some embodiments, the distance 704 is less than twice the thickness of a flange 120 (FIG. 1) of a conventional discharge nozzle 102. As noted, a typical flange is about one inch (2.5 cm) thick. Thus, in some embodiments, the distance 704 is less than about two inches (5 cm).

In some embodiments, the distance 704 is zero. In some embodiments, the distance 704 is negative, i.e., an edge portion of the blades 216-214 overlap with an edge portion of the flights of the drive screws 238 and 240. In such embodiments, at least the edge portion of the blades 216-214 and/or the edge portion of the flights of the drive screws 238 and 240 should be made of a resilient material, so the edges of the blades 216-214 and the edges of the drive screws 238 and 240 can deform as they bypass each other.

While specific parameter values may be recited for disclosed embodiments, within the scope of the invention, the values of all of parameters may vary over wide ranges to suit different applications. While the invention is described through the above-described exemplary embodiments, modifications to, and variations of, the illustrated embodiments may be made without departing from the inventive concepts disclosed herein. Furthermore, disclosed aspects, or portions thereof, may be combined in ways not listed above and/or not explicitly claimed. Accordingly, the invention should not be viewed as being limited to the disclosed embodiments.

1. A thin-film evaporator comprising:
a cylindrical body having a longitudinal axis and defining an inner surface and an inner volume within the inner surface;
a feed nozzle in fluid communication with the inner volume of the cylindrical body;
a rotor assembly disposed within the inner volume of the cylindrical body and having an axis of rotation coaxial with the cylindrical body;
at least one blade disposed within the inner volume of the cylindrical body, adjacent the inner surface of the cylindrical body, and attached to the rotor assembly for rotation therewith;
an elongated body having a longitudinal axis and defining an inner volume, the elongated body being tangent to and intersecting the cylindrical body to define a window therebetween, the inner volume of the cylindrical body being in fluid communication with the inner volume of the elongated body via the window;
at least one drive screw disposed within the inner volume of the elongated body and having an axis of rotation parallel to the longitudinal axis of the elongated body; and
a discharge nozzle in fluid communication with the inner volume of the elongated body.

2. A thin-film evaporator according to claim 1, wherein:
the at least one blade defines a circumference swept by an outer edge thereof; and
the at least one drive screw comprises a flight having an outer circumference, a tangent of which is located less than about two inches from the circumference swept by the outer edge of the at least one blade.

3. A thin-film evaporator according to claim 1, wherein:
the at least one blade defines a circumference swept by an outer edge thereof;
the feed nozzle comprises a flange having a flange thickness; and
the at least one drive screw comprises a flight having an outer circumference, a tangent of which is located less than about two times the flange thickness from the circumference swept by the outer edge of the at least one blade.

4. A thin-film evaporator according to claim 1, wherein:
the at least one blade defines a circumference swept by an outer edge thereof; and
the at least one drive screw comprises a flight having an outer circumference, a tangent of which is located no more than about ¼ inch from the circumference swept by the outer edge of the at least one blade.

5. A thin-film evaporator according to claim 1, wherein:
the at least one blade defines a circumference swept by an outer edge thereof; and
the at least one drive screw comprises a flight having an outer circumference, a tangent of which is located no more than about 3/16 inch from the circumference swept by the outer edge of the at least one blade.

6. A thin-film evaporator according to claim 1, wherein:
the at least one blade defines a circumference swept by an outer edge thereof; and
the at least one drive screw comprises a flight having an outer circumference, a tangent of which is located no more than about 1/16 inch from the circumference swept by the outer edge of the at least one blade.

7. A thin-film evaporator according to claim 1, wherein:
the at least one blade defines a circumference swept by an outer edge thereof; and
the at least one drive screw comprises a flight having an outer circumference, a tangent of which is located about zero inches from the circumference swept by the outer edge of the at least one blade.

8. A thin-film evaporator according to claim 1, wherein:
the at least one blade defines a circumference swept by an outer edge thereof; and
the at least one drive screw comprises a flight having an outer circumference that overlaps the circumference swept by the outer edge of the at least one blade.

9. A thin-film evaporator according to claim 1, wherein:
the at least one blade defines a circumference swept by an outer edge thereof; and
the at least one drive screw comprises a flight having an outer circumference, a tangent of which is located a distance between about 1/16 inch and about 1/4 inch from the circumference swept by the outer edge of the at least one blade.

10. A thin-film evaporator according to claim 1, wherein:
the at least one blade defines a circumference swept by an outer edge thereof; and
the at least one drive screw comprises a flight having an outer circumference, a tangent of which is located a distance between about 1/16 inch and about 1/8 inch from the circumference swept by the outer edge of the at least one blade.

11. A thin-film evaporator according to claim 1, wherein:
the cylindrical body comprises a wall that defines the window, the wall having a wall thickness extending from the inner surface of the cylindrical body, and the inner surface of the cylindrical body defines an inner surface circumference; and
the at least one drive screw comprises a flight having an outer circumference, a tangent of which is located a distance from the inner surface circumference of the cylindrical body less than the wall thickness.

12. A thin-film evaporator according to claim 1, wherein the longitudinal axis of the cylindrical body is substantially perpendicular to the longitudinal axis of the elongated body.

13. A thin-film evaporator according to claim 1, wherein the at least one drive screw comprises two parallel intermeshed drive screws that are configured to co-rotate.

14. A thin-film evaporator according to claim 1, wherein the at least one drive screw comprises two parallel intermeshed drive screws that are configured to counter-rotate.

15. A thin-film evaporator according to claim 1, wherein the cylindrical body intersects the elongated body along a weld.

16. A thin-film evaporator according to claim 1, further comprising:
a jacket surrounding at least a portion of the cylindrical body to define a volume between the jacket and the cylindrical body configured to transfer heat between a fluid flowing through the volume and the cylindrical body;
a heat exchange fluid feed nozzle in fluid communication with the volume defined by the jacket; and
a heat exchange fluid discharge nozzle in fluid communication with the volume defined by the jacket.

17. A thin-film evaporator according to claim 1, wherein the at least one drive screw is configured to rotate about its axis of rotation in a direction to transport material from the window, through at least a portion of the inner volume of the elongated body, toward the discharge nozzle.
